(19) United States
(12) Patent Application Publication
(10) Pub. No.: US 2007/0239939 A1
(43) Pub. Date: Oct. 11, 2007

(54) Apparatus for Performing Stream Prefetch within a Multiprocessor System

(76) Inventors: Benjiman L. Goodman, Cedar Park, TX (US); Jeffrey A. Stuecheli, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/278,825

(22) Filed: Apr. 6, 2006

(51) Int. Cl. G06F 12/00

(52) U.S. Cl. 711/137

(57) ABSTRACT

An apparatus for performing stream prefetch within a multiprocessor system is disclosed. The multiprocessor system includes a first and second processors, and each of the processors includes a primary cache and a secondary cache. A stream register having multiple entries is initially provided within the first processor, and at least one of the entries in the stream register includes a prefetch history field. The bit in the prefetch history field associated with a sequential address stream is set in response to the sequential address stream being found in the secondary cache of the second processor after a system memory operation has been performed by the first processor. The bit in the prefetch history field associated with the same sequential address stream is reset in response to the sequential address stream not being found in the secondary cache of the second processor after a cache memory operation has been performed by the first processor. The bit in the prefetch history field serves as a basis for a subsequent prefetch on the same sequential address stream to decide whether the data should come from a cache memory operation or a system memory operation.

### BACKGROUND OF THE INVENTION

1. Technical Field

The present invention relates to hardware prefetchers in general, and more particularly, to hardware prefetchers for performing stream prefetch. Still more particularly, the present invention relates to a processor having a hardware prefetcher for performing stream prefetch within a multiprocessor system.

2. Description of Related Art

As the gap between memory latency and processor frequency begins to grow further and further apart, computer architects turn to two primary methods to maintain system performance, namely, data caching (for handling previously used data) and data prefetching (for handling data expected to be used). Data prefetching tends to have better results in speed improvement for applications where cache memories are not effective.

Hardware prefetchers designed to perform data prefetching are generally capable of detecting sequential address streams. A sequential address stream is defined as any sequence of storage accesses that reference a contiguous set of cache lines in a monotonically increasing or decreasing manner. In response to a detection of a sequential address stream, a hardware prefetcher begins to prefetch data up to a predetermined number of cache lines ahead of the data currently being processed.

Prior art stream prefetch mechanisms typically include support for software instructions to control certain aspects of the hardware prefetcher, such as instructions to define the start and end of a software stream, when prefetching can be started, and the total number of outstanding prefetches allowed at any given time. While such instructions are useful, the most effective depth of prefetching in a high-latency multiprocessor system depends upon other factors such as the number of other streams currently being prefetched and the rate of consumption of each of those streams by various applications.

The present disclosure provides an improved hardware prefetcher performing stream prefetch within a multiprocessor system.

### SUMMARY OF THE INVENTION

In accordance with a preferred embodiment of the present invention, a multiprocessor system includes a first and second processors, and each of the processors includes a primary cache and a secondary cache. A stream register having multiple entries is initially provided within the first processor, and at least one of the entries in the stream register includes a prefetch history field. The bit in the prefetch history field associated with a sequential address stream is set in response to the sequential address stream being found in the secondary cache of the second processor after a memory-optimized operation has been performed by the first processor. The bit in the prefetch history field associated with the same sequential address stream is reset in response to the sequential address stream not being found in the secondary cache of the second processor after a cache-optimized operation has been performed by the first processor. The bit in the prefetch history field serves as a basis for a subsequent prefetch on the same sequential address stream to decide whether the data should come from a cache-optimized operation or a memory-optimized operation.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a multiprocessor system, in accordance with a preferred embodiment of the present invention;

FIG. 2 is a block diagram of a load/store unit within a processor from FIG. 1, in accordance with a preferred embodiment of the present invention;

FIG. 3 is a block diagram of a hardware prefetcher within the load/store unit from FIG. 2, in accordance with a preferred embodiment of the present invention;

FIG. 4 is a block diagram of a stream register within the hardware prefetcher from FIG. 3, in accordance with a preferred embodiment of the present invention; and

FIG. 5 is a high-level logic flow diagram of a method for performing stream prefetch within the multiprocessor system from FIG. 1, in accordance with a preferred embodiment of the present invention.

### DETAILED DESCRIPTION OF A PREFERRED EMBODIMENT

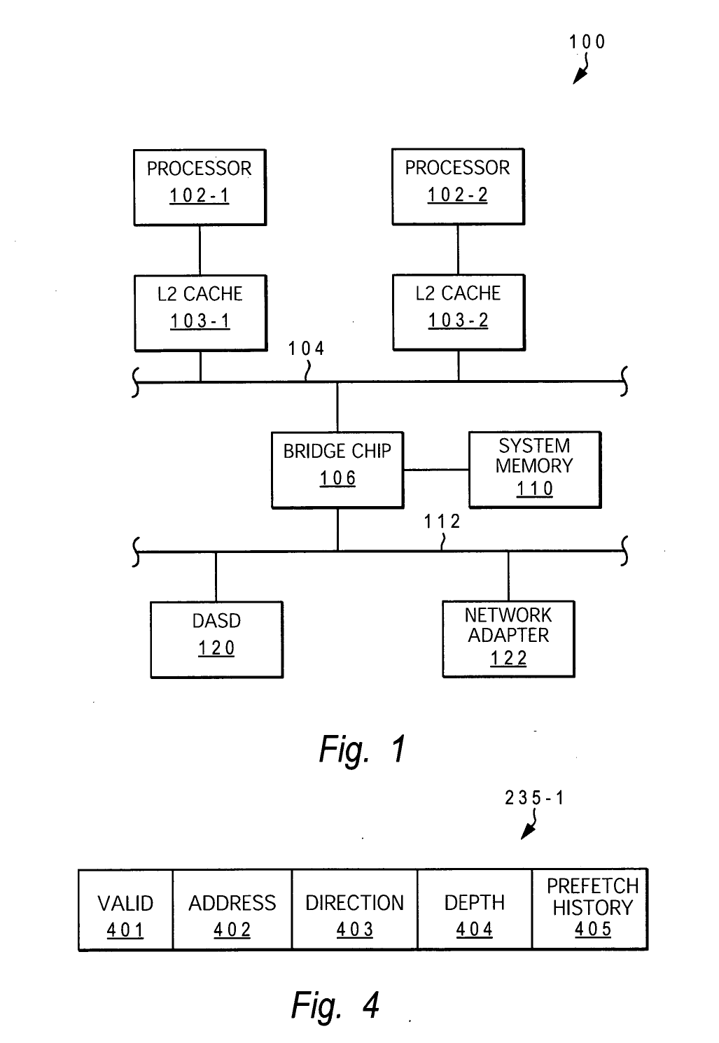

Referring now to the drawings and in particular to FIG. 1, there is depicted a block diagram of a multiprocessor system, in accordance with a preferred embodiment of the present invention. As shown, a multiprocessor system 100 includes processors 102-1 and 102-2, each having a level one (L1) cache (not shown). Processors 102-1 and 102-2 are coupled to level 2 (L2) cache memories 103-1 and 103-2, respectively, which are connected to a host bus 104. A bridge chip 106 provides an interface between host bus 104 and a system memory 110. Bridge chip 106 also provides a bridge between host bus 104 and a peripheral bus 112 to which a direct access storage device 120 and a network adapter 122 are attached.

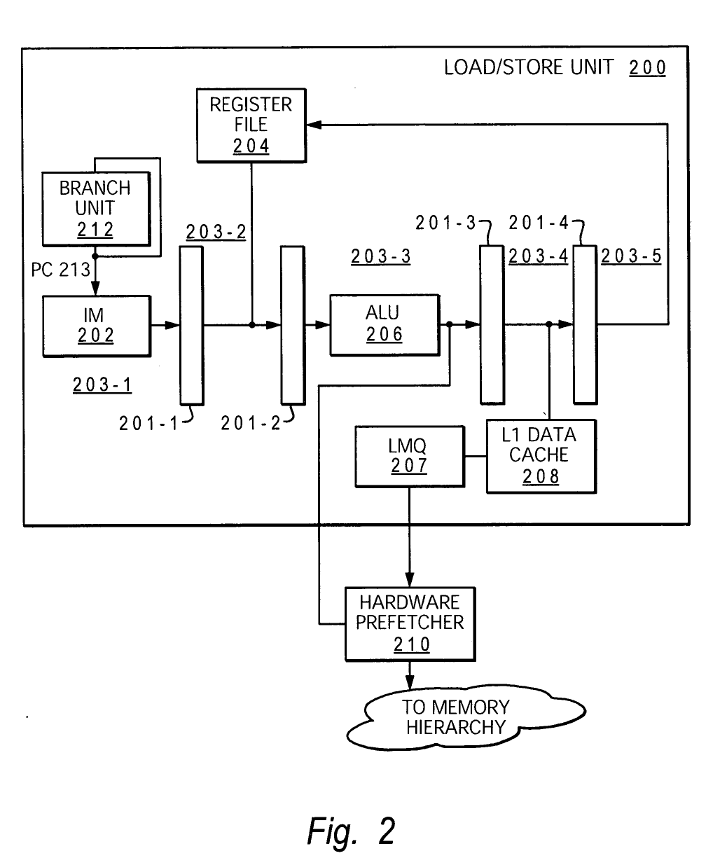

With reference now to FIG. 2, there is depicted a block diagram of a load/store unit (LSU) within processor 102-1 (and similarly processor 102-2) in which a preferred embodiment of the present invention is incorporated. As a pipelined unit, an LSU 200 includes a series of latches 201-1 through 201-4 that defines various stages of LSU 200.

Stage 203-1 is an instruction fetch stage in which a branch unit 212 predicts the address of a next instruction to execute and provides a program count (PC) 213 to an instruction memory (IM) 202. Stage 203-2 is an instruction decode stage in which values in the registers referenced by the instruction are retrieved from a register file 204. In an instruction execution stage 203-3, an arithmetic logic unit (ALU) 206 produces a value based on the register values retrieved in decode stage 203-2. In the context of a load or store instruction, ALU 206 produces an address for the load or store instruction. In a memory access stage 203-4, the address generated in execution stage 203-3 is used to access an L1 data cache 208 to retrieve data (assuming there was an address hit in L1 data cache 208) in the case of a load instruction. In a write back stage 203-5, data retrieved from L1 data cache 208 are written back to register file 204 for a load instruction; and, for a store instruction, the address produced by ALU 206 for the store data is buffered in a store queue until the data is produced. Execution of a load instruction proceeds efficiently (i.e., memory latency is not a concern) as long as the addresses generated by ALU 206 “hits” in L1 data cache 208.

However, if the address misses in L1 data cache 208, then there is a likelihood of significant latency penalty. A latency penalty refers to the number of processor cycles required to retrieve data from the memory hierarchy that includes L2 cache memories 103-1, 103-2 and system memory 110 (from FIG. 1).

A hardware prefetcher 210 is utilized to minimize, if not avoid, latency penalties. Hardware prefetcher 210 receives addresses generated by ALU 206 and has accesses to a load miss queue (LMQ) 207. LMQ 207 stores addresses associated with load instructions or L1 prefetches that have missed in L1 data cache 208. Store instructions that miss in L1 data cache 208 do not generate L1 prefetch requests.

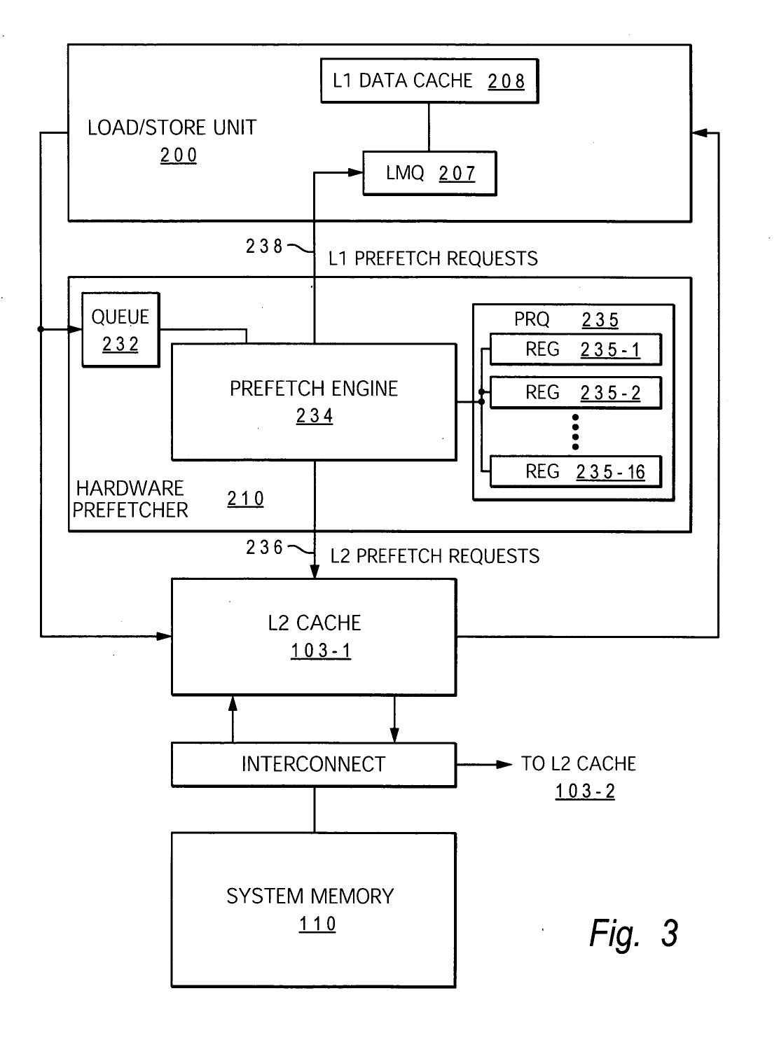

Referring now to FIG. 3, there is depicted a block diagram of hardware prefetcher 210, in accordance with a preferred embodiment of the present invention. As shown, hardware prefetcher 210 includes a queue 232 that buffers addresses generated by LSU 200. Queue 232 provides the buffered addresses to a stream prefetch engine 234.

Prefetch engine 234 controls a prefetch request queue (PRQ) 235 to generate L1 prefetch requests 238 and L2 prefetch requests 236. Specifically, prefetch engine 234 controls the allocation of a set of stream registers 235-1 through 235-16 within PRQ 235. After reviewing addresses received from LSU 200, hardware prefetcher 210 identifies new sequential data streams and advances the state of existing sequential data streams. If an address received from LSU 200 matches any of the addresses in stream registers 235-1 through 235-16, the state of the corresponding prefetch sequential data stream is advanced.

If an address received from LSU 200 does not match any of the addresses in stream registers 235-1 through 235-16, hardware prefetcher 210 determines if a new sequential data stream address should be generated, and if so, which one of stream registers 235-1 through 235-16 should receive the new sequential data stream assignment. A new sequential data stream can be generated by storing an address in the selected stream register. For loads instructions, a new sequential data stream is generated if two conditions are met: (1) the load instruction missed in the L1 cache and (2) the address associated with the load instruction (or specifically, the cache line associated with the data address of the load instruction) is not found in any entries of LMQ 207 that is an indication that a reload request or L1 prefetch has not yet been sent for that cache line.

L1 prefetch requests 238 and L2 prefetch requests 236 cause data from the memory subsystem to be fetched or retrieved into L1 data cache 208 and L2 cache 103-1, respectively, preferably before the data is needed by LSU 200. The concept of prefetching recognizes that data accesses frequently exhibit spatial locality. Spatial locality suggests that the address of the next memory reference is likely to be near the address of recent memory references. A common manifestation of spatial locality is a sequential data stream, in which data from a block of memory is accessed in a monotonically increasing (or decreasing) sequence such that contiguous cache lines are referenced by at least one instruction. When hardware prefetcher 210 detects a sequential data stream (e.g., references to addresses in adjacent cache lines), it is reasonable to predict that future references will be made to addresses in cache lines that are adjacent to the current cache line (the cache line corresponding to currently executing memory references) following the same direction.

Hardware prefetcher 210 causes a processor, such as processor 102-1 from FIG. 1, to retrieve one or more of these adjacent cache lines before the program actually requires them. As an example, if a program loads an element from a cache line n, and then loads an element from cache line n+1, hardware prefetcher 210 may prefetch cache lines n+2 and n+3, anticipating that the program will soon load from those cache lines also.

Since stream registers 235-1 through 235-16 are substantially identical to each other, only stream register 235-1 will be further described in details. With reference now to FIG. 4, there is depicted a block diagram of stream register 235-1, in accordance with a preferred embodiment of the present invention. Stream register 235-1 contains information that describes various attributes of a corresponding sequential data stream. As shown, stream register 235-1 includes a valid field 401, an address field 402, a direction field 403, a depth field 404 and a prefetch history field 405.

Valid field 401 indicates whether or not stream register 235-1 is valid. Address field 402 contains the address of the first cache line in a sequential data stream. Direction field 403 indicates whether or not the address the sequential data stream is to be incremented or decremented. Depth field 404 indicates the level of prefetching associated with the corresponding sequential data stream (e.g., aggressive or conservative).

Prefetch history field 405 indicates whether or not the previous prefetched data stream was observed to be stored in an off-chip cache memory associated with a memory hierarchy from different processor. For example, in multiprocessor system 100 of FIG. 1, prefetch history field 405 of stream register 235-1 within processor 102-1 indicates whether or not a previous prefetched data stream was observed to be stored in L2 cache 103-2 associated with processor 102-2 (it is assumed that processor 102-1 is aware of all the data stored in L2 cache 103-1 by imposing an inclusive policy on L2 cache 103-1). The bit in prefetch history field 405 is set (e.g., a logical “1”) after the previous prefetched data stream was actually utilized by an executing program; otherwise, the bit in prefetch history field 405 is reset (e.g., a logical “0”) if the previous prefetched data stream was ignored by the executing program.

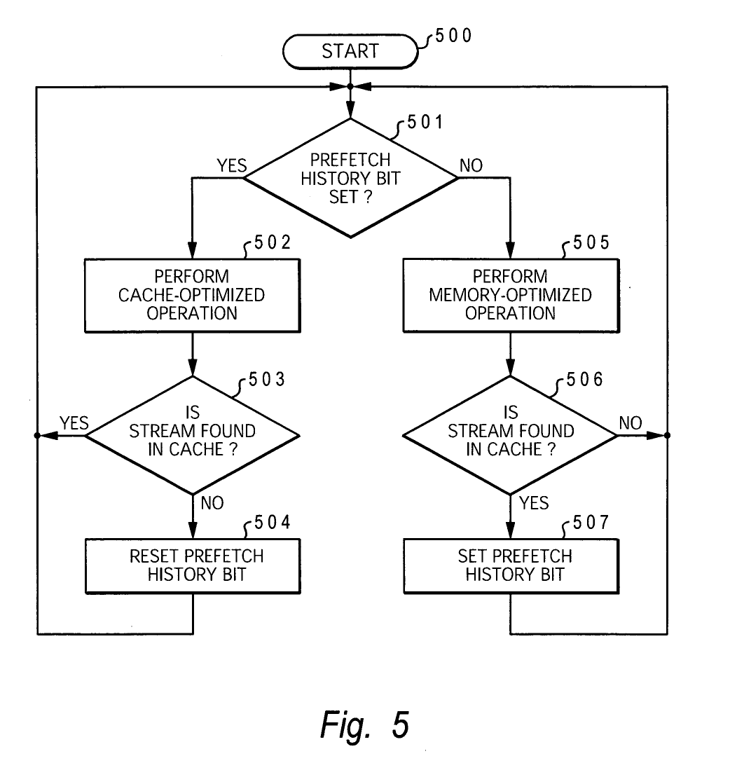

Referring now to FIG. 5, there is depicted a high-level logic flow diagram of a method for performing stream prefetch within multiprocessor system 100 (from FIG. 1), in accordance with a preferred embodiment of the present invention. Starting at block 500, a determination is made as to whether or not a bit in a prefetch history field (such as prefetch history field 405 in FIG. 4) in a stream register within processor 102-1 is set, as shown in block 501. If the bit in the prefetch history field is set, a cache-optimized prefetch operation is performed, as depicted in block 502. Next, another determination is made as to whether or not the sequential data stream is actually found in one of L2 cache memories, such as L2 cache 103-2 from FIG. 1, as shown in block 503. If the sequential data stream is actually found in one of the L2 cache memories, the process returns to block 501; otherwise, if the sequential data stream is not found in one of the L2 cache memories, the bit in the prefetch history field is reset, as depicted in block 504, before the process returns to block 501.

However, if the bit in the prefetch history field is not set, then a memory-optimized prefetch operation is performed, as shown in block 505. Then, another determination is made as to whether or not the sequential data stream is actually found in one of the L2 cache memories, as depicted in block 506. If the sequential data stream is not found in one of the L2 cache memories, the process returns to block 501; otherwise, if the sequential data stream is found in one of the L2 cache memories, the bit in the prefetch history field is set, as shown in block 507, before the process returns to block 501.

As has been described, the present invention provides a hardware prefetcher for performing stream prefetch within a multiprocessor system. In the present embodiment, it is assumed that a processor within the multiprocessor system is aware of all the data stored in its off-chip L2 cache memory by imposing an inclusive policy on its off-chip L2 cache memory; however, when the inclusive policy is not implemented, the bit within a prefetch history field of the processor would also associate with its off-chip L2 cache memory. Although only one bit is shown to be used in a prefetch history field to associate with more than one off-chip L2 cache memory, it is understood by those skilled in the art that more bits can be used in the prefetch history field, with each bit associating with a respective off-chip L2 cache memory.

It is also important to note that although the present invention has been described in the context of a multiprocessor system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact discs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for performing stream prefetch within a multiprocessor system having a first and second processors, wherein each of said processors includes a cache, said method comprising:
providing in said first processor a stream register having a plurality of entries, wherein at least one of said entries includes a prefetch history field;
setting a bit in said prefetch history field associated with a sequential data stream in response to said sequential data stream being found in said cache of said second processor after a system memory operation has been performed by said first processor; and
resetting said bit in said prefetch history field associated with said sequential data stream in response to said sequential data stream being not found in said cache of said second processor after a cache memory operation has been performed by said first processor.

2. The method of claim 1, wherein said method further includes maintaining said bit in said prefetch history field to be set in response to said sequential data stream being found in said cache of said second processor after said cache memory operation has been performed by said first processor.

3. The method of claim 1, wherein said method further includes maintaining said bit in said prefetch history field to be reset in response to said sequential data stream being not found in said cache of said second processor after said system memory operation has been performed by said first processor.

4. The method of claim 1, wherein said method further includes generating a new sequential data stream when a load instruction is missed in said cache of said first processor and an address associated with said load instruction is not found in any entry of said stream register.

5. An apparatus for performing stream prefetch within a multiprocessor system having a first and second processors, wherein each of said processors includes a cache, said apparatus comprising:
a stream register in said first processor, wherein said stream register includes a plurality of entries, wherein at least one of said entries includes a prefetch history field;
means for setting a bit in said prefetch history field associated with a sequential data stream in response to said sequential data stream being found in said cache of said second processor after a system memory operation has been performed by said first processor; and
means for resetting said bit in said prefetch history field associated with said sequential data stream in response to said sequential data stream being not found in said cache of said second processor after a cache memory operation has been performed by said first processor.

6. The apparatus of claim 5, wherein said apparatus further includes means for maintaining said bit in said prefetch history field to be set in response to said sequential data stream being found in said cache of said second processor after said cache memory operation has been performed by said first processor.

7. The apparatus of claim 5, wherein said apparatus further includes means for maintaining said bit in said prefetch history field to be reset in response to said sequential data stream being not found in said cache of said second processor after said system memory operation has been performed by said first processor.

8. The apparatus of claim 5, wherein said apparatus further includes means for generating a new sequential data stream when a load instruction is missed in said cache of said first processor and an address associated with said load instruction is not found in any entry of said stream register.

9. A computer usable medium having a computer program product for performing stream prefetch within a multiprocessor system having a first and second processors, wherein each of said processors includes a cache, said computer usable medium comprising:
program code means for providing a stream register in said first processor, wherein said stream register includes a plurality of entries, wherein at least one of said entries includes a prefetch history field;
program code means for setting a bit in said prefetch history field associated with a sequential data stream in response to said sequential data stream being found in said cache of said second processor after a system memory operation has been performed by said first processor; and
program code means for resetting said bit in said prefetch history field associated with said sequential data stream in response to said sequential data stream being not found in said cache of said second processor after a cache memory operation has been performed by said first processor.

10. The computer usable medium of claim 9, wherein said computer usable medium further includes program code means for maintaining said bit in said prefetch history field to be set in response to said sequential data stream being found in said cache of said second processor after said cache memory operation has been performed by said first processor.

11. The computer usable medium of claim 9, wherein said computer usable medium further includes program code means for maintaining said bit in said prefetch history field to be reset in response to said sequential data stream being not found in said cache of said second processor after said system memory operation has been performed by said first processor.

12. The computer usable medium of claim 9, wherein said computer usable medium further includes program code means for generating a new sequential data stream when a load instruction is missed in said cache of said first processor and an address associated with said load instruction is not found in any entry of said stream register.
